(19) United States
(12) Patent Application Publication
(10) Pub. No.: US 2020/0220577 A1
(43) Pub. Date: Jul. 9, 2020

(54) WIRELESS CHARGING SIGNAL TRANSMITTING METHOD AND WIRELESS POWER TRANSMITTING UNIT THEREOF

(71) Applicant: NEWVASTEK CO., LTD., TAIPEI CITY (TW)

(72) Inventors: Ming-Liang Fang, TAIPEI CITY (TW); Sheng-Kuan Chen, TAIPEI CITY (TW); Chih-Hao Chuang, TAIPEI CITY (TW)

(73) Assignee: NEWVASTEK CO., LTD., TAIPEI CITY (TW)

(21) Appl. No.: 16/737,017

(22) Filed: Jan. 8, 2020

(30) Foreign Application Priority Data
Jan. 9, 2019 (TW) 108100910

(51) Int. Cl. H04B 5/00; H02J 50/80; H02J 50/90; H02J 50/12

(52) U.S. Cl. CPC H04B 5/0037; H02J 50/12; H02J 50/90; H02J 50/80

(57) ABSTRACT

A wireless charging signal transmitting method includes continuously transmitting short beacons in a time cycle, each short beacon being used to detect a load change; and transmitting a long beacon only when the short beacons detect the load change to start detecting one or more connection broadcast signals. Moreover, a wireless power transmitting unit is also provided. Accordingly, the method and the device reduce the power consumption of a wireless charging system during the standby period.

### CROSS-REFERENCE TO RELATED APPLICATION

This non-provisional application claims priority under 35 U.S.C. § 119(a) to Patent Application No. 108100910 filed in Taiwan, R.O.C. on Jan. 9, 2019, the entire contents of which are hereby incorporated by reference.

### BACKGROUND

### Technical Field

The present invention relates to a wireless charging technology, and more particularly to a wireless charging signal transmitting method and a wireless power transmitting unit thereof.

### Related Art

In order to facilitate the charging of portable electronic devices, the development of the wireless charging technology is increasingly mature. Through the wireless charging technology, the portable electronic device can be charged in a wireless induction manner without a charging wire, as long as it is close to or in contact with a wireless power supply terminal (a wireless charging station).

In the wireless charging standards of alliance for wireless power (A4WP), the wireless charging system includes a power transmitting unit (PTU) and a power receiving unit (PRU), which are inductively coupled by an induction coil. During the initial standby period of the wireless charging system, the power transmitting unit periodically transmits a beacon sequence signal through the induction coil, and the beacon sequence signal usually includes a short beacon and a long beacon for detecting the presence or absence of the power receiving unit. When the power transmitting unit is in the standby period, there are multiple long beacon periods (t_{LONG_BEACON_PERIOD}), each long beacon period has a long beacon (t_{LONG_BEACON}), multiple short beacons (t_{SHORT_BEACON}) appear during this period, the adjacent short beacons have a time cycle (t_{CYCLE}), and the short beacons are substantially identical in time length, but different in power. The time length of the long beacon is several times that of the short beacon and its power is greater than that of the short beacon.

### SUMMARY

Based on the above, when a power transmitting unit is in the standby period, multiple short beacons and multiple long beacons need to be continuously transmitted, so the overall power consumption is large. The long beacons consume more power than the short beacons, so the transmitting of multiple long beacons causes the problem of excessive power consumption of a wireless charging system during the standby period.

In view of this, the present invention proposes a wireless charging signal transmitting method and a wireless power transmitting unit thereof to solve the problem of excessive power consumption of a wireless charging system during the standby period.

In an embodiment, a wireless charging signal transmitting method is applied to a wireless power transmitting unit, the wireless charging signal transmitting method comprising: continuously transmitting short beacons in a time cycle, each short beacon being used to detect a load change; and transmitting a long beacon only when the short beacons detect the load change to start detecting at least one connection broadcast signal.

In an embodiment, a wireless power transmitting unit at least comprises a transmitting resonator and a control circuit. The transmitting resonator is configured to transmit short beacons in a time cycle, each short beacon being used to detect a load change; the control circuit is electrically connected to the transmitting resonator and configured to instruct the transmitting resonator to transmit short beacons in the time cycle, and only when the short beacons detect the load change, the control circuit instructs, in response to the load change, the transmitting resonator to transmit a long beacon to start detecting at least one connection broadcast signal.

In some embodiments, the time cycle between the short beacons is more than 255 milliseconds (ms) and less than 6 seconds.

In summary, the present invention removes the part of the long beacons appearing cyclically and prolongs the appearing time of the short beacons, thereby reducing the power consumption of the wireless charging system during the standby period.

### BRIEF DESCRIPTION OF THE DRAWINGS

FIG. 1 is a block schematic diagram of a wireless charging system according to an embodiment of the present invention.

FIG. 2 is a schematic diagram of a beacon sequence signal according to an embodiment of the present invention.

FIG. 3 is a flow diagram of a wireless charging signal transmitting method according to an embodiment of the present invention.

FIG. 4 is a schematic diagram of a beacon sequence signal according to another embodiment of the present invention.

### DETAILED DESCRIPTION

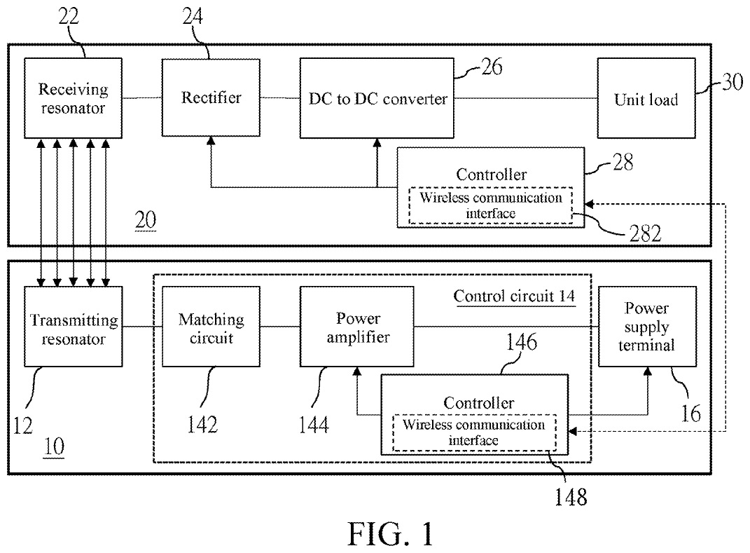

FIG. 1 is a block schematic diagram of a wireless charging system according to an embodiment of the present invention. Referring to FIG. 1, the wireless charging system includes a wireless power transmitting unit (PTU) 10 and a wireless power receiving unit (PRU) 20. The wireless power receiving unit 20 includes a receiving resonator 22, a rectifier 24, a DC to DC converter 26, a controller 28 and a unit load 30. The wireless power transmitting unit 10 includes a transmitting resonator 12, a control circuit 14 and a power supply terminal 16, and the control circuit 14 is electrically connected to the transmitting resonator 12 and the power supply terminal 16.

In the wireless power transmitting unit 10, the transmitting resonator 12 includes at least one resonant coil driven by the control circuit 14 to transmit short beacons in a time cycle or a long beacon. The control circuit 14 gives the transmitting resonator 12 different instructions according to different states, so that the transmitting resonator 12 transmits short beacons or long beacons under the drive of the control circuit 14.

In some embodiments, the control circuit 14 of the wireless power transmitting unit 10 includes a matching circuit 142, a power amplifier 144 and a controller 146, wherein the matching circuit 142 is electrically connected with the transmitting resonator 12, the power amplifier 144 is electrically connected with the matching circuit 142 and the power supply terminal 16, and the controller 146 is electrically connected with the power amplifier 144 and the power supply terminal 16.

In some embodiments, the power supply terminal 16 is connected to any power output device, such as a power supply, a DC adapter or a voltage regulator, to supply power (power generated by an AC/DC adapter or AC power), the power amplifier 144 receives the power, amplifies the power into a desired power signal according to an instruction of the controller 146 and then transmits the power signal to the matching circuit 142, and the matching circuit 142 receives the power signal from the power amplifier 144 to match appropriate impedance so as to provide substantially stable power for the transmitting resonator 12 for power transmission. In the wireless power receiving unit 20, the controller 28 instructs each component to operate, the receiving resonator 22 receives an inductive power from the transmitting resonator 12, the inductive power is first rectified by the rectifier 24 and then transmitted to the DC to DC converter 26 for conversion to a desired DC load voltage, and the DC load voltage is supplied to the unit load 30 for charging.

The controller 146 of the wireless power transmitting unit 10 further has a built-in wireless communication interface 148, and the controller 28 of the wireless power receiving unit 20 also has a built-in wireless communication interface 282, so that the wireless communication interface 148 of the wireless power transmitting unit 10 and the wireless communication interface 282 of the wireless power receiving unit 20 can be paired or configured to establish a communication connection in accordance with a wireless communication standard. In some embodiments, the wireless communication standard may be a communication protocol of any specification, e.g., Bluetooth or Bluetooth low energy (BLE), etc., but the present invention is not limited thereto. In some embodiments, the wireless communication interfaces 148, 282 may also be separated from the controllers 146, 28 respectively, depending on user requirements or actual circuit design.

In some embodiments, the wireless communication interface 148 of the wireless power transmitting unit 10 is configured to transmit a broadcast signal or detect a broadcast signal transmitted from the wireless power receiving unit 20, so that the wireless power transmitting unit 10 is connected with the wireless power receiving unit 20 for communication.

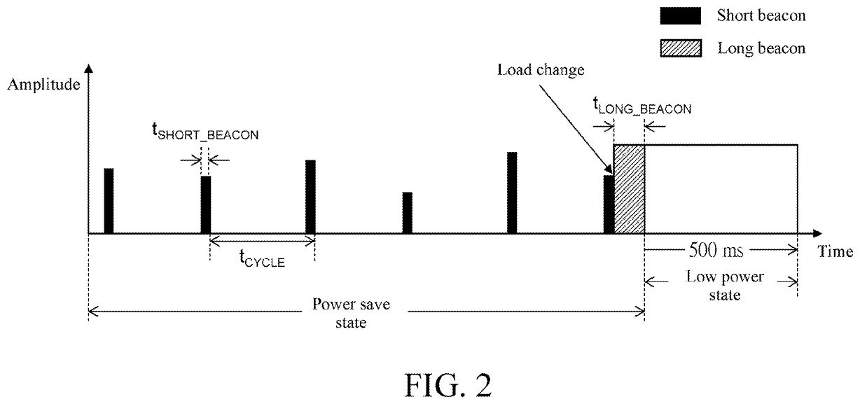

Referring to FIG. 1 and FIG. 2 simultaneously, the control circuit 14 instructs the transmitting resonator 12 in a power save state to transmit a short beacon at an interval, the short beacon being transmitted in a time cycle, wherein the time cycle t_{CYCLE} is more than 255 milliseconds and less than 6 seconds, and the duration t_{SHORT_BEACON} of transmitting the short beacon every time is 10 to 30 milliseconds. If no load change occurs, the transmitting resonator 12 continuously transmits short beacons in a time cycle until the short beacons detect a load change of the wireless power transmitting unit 10, wherein the load change may be an impedance change of the wireless power transmitting unit 10.

When the short beacons detect the load change, the control circuit 14 instructs, in response to the load change, the transmitting resonator 12 to transmit a long beacon, so that the wireless power transmitting unit 10 enters a low power state. In a preferred embodiment, the duration t_{LONG_BEACON} of transmitting a long beacon is 100 to 110 milliseconds. Based on the above, the wireless power transmitting unit 10 transmits the short beacons only cyclically during the standby period, and transmits a long beacon only when the short beacons detect the load change of the wireless power transmitting unit 10.

In some embodiments, the production of load change (impedance change) may be caused by the wireless power receiving unit 20 placed on or close to the wireless power transmitting unit 10, or caused by the conductive metal of a metal object (e.g, a key, a coin, etc.), so the presence or absence of the wireless power receiving unit 20 must be further confirmed in the low power state.

In some embodiments, when the wireless charging system is in a standby phase, that is, the wireless power transmitting unit 10 is in the power save state and the low power state, and this period in the two states is called a standby phase (also called a standby period).

When the wireless power transmitting unit 10 is in the low power state, if no wireless power receiving unit 20 is detected during this period (i.e., no connection broadcast signal is received), the wireless power transmitting unit 10 returns to the power save state, and the control circuit 14 instructs the transmitting resonator 12 again to begin transmitting cyclic short beacons. Conversely, when the control circuit 14 detects a connection broadcast signal sent by the wireless power receiving unit 20 in the low power state, the control circuit 14 and the wireless power receiving unit 20 establish and maintain a connection to enter a charging phase, so that the wireless power receiving unit 20 starts to receive the power (magnetic resonance coupling current) of the wireless power transmitting unit 10 for wireless charging.

In some embodiments, the connection broadcast signal may correspond to the wireless communication standard used above, and may be a Bluetooth signal or a Bluetooth low energy signal.

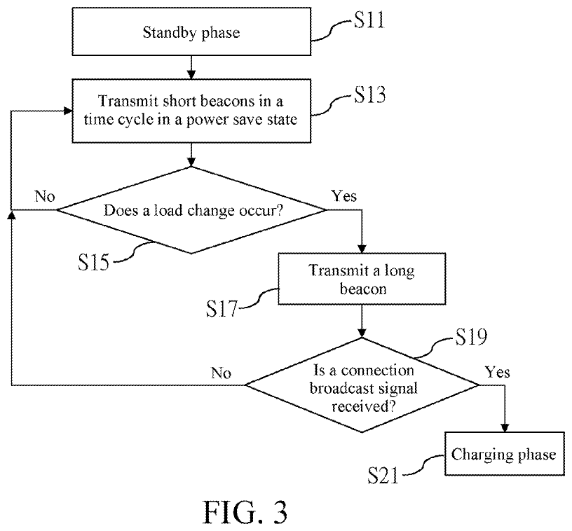

Here, the wireless power transmitting unit 10 starts a wireless charging signal transmitting method. Referring to FIG. 1 to FIG. 4, when the wireless power transmitting unit 10 is initialized and starts to enter a standby phase (step S11), it indicates that the wireless power transmitting unit 10 starts to enter the power save state.

In the power save state, the control circuit 14 of the wireless power transmitting unit 10 instructs the transmitting resonator 12 to continuously transmit short beacons in a time cycle (e.g., more than 255 milliseconds and less than 6 seconds) (step S13). In this power save state, only short beacons are cyclically transmitted for detection.

The control circuit 14 detects whether the transmitting resonator 12 has a load change according to the short beacons (step S15); if a load change occurs, the process proceeds to next step (step S17); if no load change occurs, the process returns to step S13 of continuously transmitting the short beacons in a time cycle.

When the control circuit 14 of the wireless power transmitting unit 10 detects the load change according to the short beacons, the control circuit 14 instructs, in response to the load change, the transmitting resonator 12 to transmit a long beacon (step S17), so that the wireless power transmitting unit 10 enters a low power state.

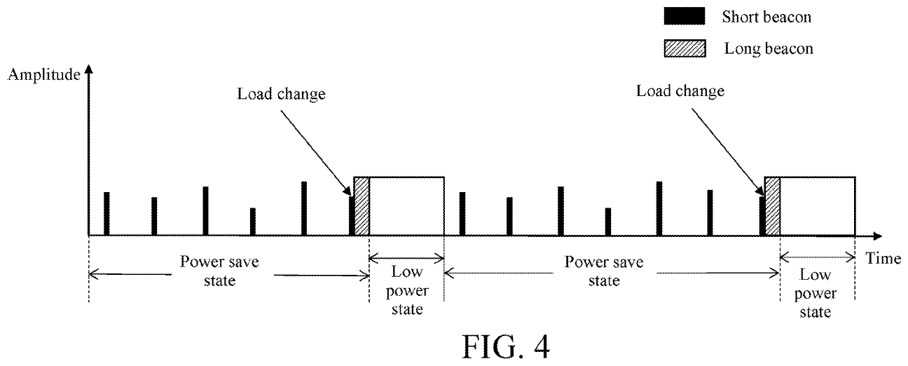

When the wireless power transmitting unit 10 is in the low power state, the control circuit 14 (via the wireless communication interface 148) starts detecting whether at least one connection broadcast signal sent by any wireless power receiving unit 20 is received (step S19). If the wireless power transmitting unit 10 does not receive the connection broadcast signal, the process returns to the step of transmitting the short beacons (returns to step S13). As shown in FIG. 4, the wireless power transmitting unit 10 starts to transmit short beacons (in the power save state) cyclically. If the wireless power transmitting unit 10 receives the connection broadcast signal, the standby phase (the power save state and the low power state) is ended and a charging phase is entered (step S21). In some embodiments, the low power state is maintained for approximately 500 milliseconds, and the wireless power transmitting unit 10 confirms whether a connection broadcast signal from the wireless power receiving unit 20 is received during this time.

Therefore, the wireless charging signal transmitting method and the wireless power transmitting unit thereof according to the present invention only periodically transmit short beacons during the period of the power save state, and prolong the appearing time of the short beacons, thereby reducing the power consumption of the wireless charging system during the standby period, and solving the problem of excessive power consumption of the conventional wireless charging system during the standby period.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A wireless charging signal transmitting method, applied to a wireless power transmitting unit, comprising:
continuously transmitting short beacons in a time cycle, each short beacon being used to detect a load change; and
transmitting a long beacon only when the short beacons detect the load change to start detecting at least one connection broadcast signal.

2. The wireless charging signal transmitting method according to claim 1, further comprising: entering a charging phase after detecting the connection broadcast signal sent by a wireless power receiving unit.

3. The wireless charging signal transmitting method according to claim 2, wherein the connection broadcast signal is a Bluetooth signal or a Bluetooth low energy signal.

4. The wireless charging signal transmitting method according to claim 1, wherein the time cycle is more than 255 milliseconds and less than 6 seconds.

5. The wireless charging signal transmitting method according to claim 1, wherein the duration of transmitting the short beacon every time is 10 to 30 milliseconds.

6. The wireless charging signal transmitting method according to claim 1, wherein the load change is an impedance change.

7. The wireless charging signal transmitting method according to claim 1, wherein the time cycle is more than 255 milliseconds and less than 6 seconds, the duration of transmitting the short beacon every time is 10 to 30 milliseconds, and the load change is the impedance change; and the charging phase is entered after the wireless power transmitting unit detects the connection broadcast signal sent by a wireless power receiving unit, and the connection broadcast signal is the Bluetooth signal or the Bluetooth low energy signal.

8. A wireless power transmitting unit, comprising:
a transmitting resonator, configured to transmit short beacons in a time cycle, each short beacon being used to detect a load change; and
a control circuit, electrically connected to the transmitting resonator, the control circuit instructing the transmitting resonator to transmit the short beacons in the time cycle, and only when the short beacons detect the load change, the control circuit instructing, in response to the load change, the transmitting resonator to transmit a long beacon to start detecting at least one connection broadcast signal.

9. The wireless power transmitting unit according to claim 8, wherein the control circuit enters a charging phase after detecting the connection broadcast signal sent by a wireless power receiving unit.

10. The wireless power transmitting unit according to claim 9, wherein the connection broadcast signal is a Bluetooth signal or a Bluetooth low energy signal.

11. The wireless power transmitting unit according to claim 8, wherein the time cycle is more than 255 milliseconds and less than 6 seconds.

12. The wireless power transmitting unit according to claim 8, wherein the duration of transmitting the short beacon every time is 10 to 30 milliseconds.

13. The wireless power transmitting unit according to claim 8, wherein the load change is an impedance change.
